(19) United States
(12) Patent Application Publication
(10) Pub. No.: US 2019/0151888 A1
(43) Pub. Date: May 23, 2019

(54) Metal Component Having Friction-Reducing Surface Coating

(71) Applicant: SIEMENS AKTIENGESELLSCHAFT, München (DE)

(72) Inventors: Felix Ntourmas, Erlangen (DE); Florian Eder, Erlangen (DE); Marek Maleika, Fürth (DE)

(73) Assignee: Siemens Aktiengesellschaft, Muenchen (DE)

(21) Appl. No.: 16/085,198

(22) PCT Filed: Mar. 13, 2017
(86) PCT No.: PCT/EP2017/055801

§ 371 Date: Feb. 4, 2019

(30) Foreign Application Priority Data
Mar. 17, 2016 (DE) 10 2016 204 447.8

(51) Int. Cl. B05D 1/00

(52) U.S. Cl. CPC B05D 1/62; B05D 2202/15; B05D 1/60

(57) ABSTRACT

Various embodiments may include a metallic component comprising: a base metal form with at least one surface; and an organic protective layer applied to at least part of the at least one surface to reduce friction. The organic protective layer is applied by treatment with a carbon-containing precursor by means of an atmospheric pressure plasma.

### CROSS-REFERENCE TO RELATED APPLICATIONS

This application is a U.S. National Stage Application of International Application No. PCT/EP2017/055801 filed Mar. 13, 2017, which designates the United States of America, and claims priority to DE Application No. 10 2016 204 447.8 filed Mar. 17, 2016, the contents of which are hereby incorporated by reference in their entirety.

### TECHNICAL FIELD

The present disclosure relates to surface coating. Various embodiments may include a metallic component having a friction-reducing surface coating, a protective coating against mechanical damage, and/or a process for carrying out surface coating and for removing the surface coating in a later process step and/or an apparatus for carrying out the process.

### BACKGROUND

In joining or assembly technology, single components are generally joined to form large components and/or assemblies, for example by screwing, clamping, and/or pressing together. Here, the components are brought into direct mechanical contact with one another. In addition, many assemblies are disassembled again into their original individual parts in the course of servicing and/or maintenance processes, for instance in order to clean them, renovate them or replace parts.

It is a problem in these and similar cases when the components which are joined and/or contact areas have to meet demanding requirements in terms of the surface quality. During assembly and/or disassembly, there is a risk of damage to these surfaces, which may lead to time-consuming and costly repairs or increased rejects. Particularly in the case of pressed joints, for example for shaft-hub connections, in the case of which the connected parts are connected frictionally with oversize fitting after joining, later release of the connection in the maintenance process is difficult without damage to the component surfaces. Pressing damage in the form of furrows, cold welding, or other surface damage frequently occurs, for example severely scratched shafts in the detachment/replacement of bearings. Components having such surface damage have to be repaired and/or reworked, if the degree of damage permits.

This results in additional manufacturing costs and may also impair the full functionality of the component or of the entire plant. Multiple reworking, for example after multiple maintenance cycles, is possible only until a permissible limiting dimension is reached, after which the component finally becomes unusable and is replaced.

In general, the use of friction-reducing lubricants and sliding aids such as oils or emulsions, which in the individual case can be applied to assist joining, detachment, and/or forming processes in the contact region of the join partners, is available for alleviating the problems described. The desired protective action is based on avoidance of direct surface contact between the elements of the join by formation of a closed film. However, a problem occurs here when the lubrication used no longer provides a closed lubrication or protective film because of nonuniform distribution, excessive point loading, and/or already greatly deformed or spalled microstructures of the surfaces. The outlays for reworking as encountered in practice, for example for correction of pressing seat damage show the unsatisfactory effectiveness of solutions employed hitherto. In addition, oil residues on the assembly and/or in the workplace serve as undesirable collection points for sheared-off microparticles from the process or environment-related contamination, for example dust particles, lead to increasing soiling, so that regular cleaning processes are necessary during the course of the work.

### SUMMARY

The teachings of the present disclosure may be used to address the disadvantages of the prior art and, in particular, make available an agent for, even if only temporary, surface protection and/or for reducing the surface roughness and/or the coefficient of friction for the technology mentioned at the outset. For example, some embodiments may include a metallic component having an organic protective layer which has been applied to at least part of the surface in order to reduce friction and is obtainable by treatment with a carbon-containing precursor by means of an atmospheric pressure plasma.

In some embodiments, the coated surface has a thermal conductivity in the range from 10 to 150 W/mK.

In some embodiments, the carbon-containing precursor is an unsaturated compound having at least one carbon-carbon multiple bond.

In some embodiments, the organic protective layer has a thickness of less than 1 μm.

In some embodiments, the organic protective layer has a thickness of less than 500 nm.

In some embodiments, the organic protective layer has an absorption in the wavelength range of visible light, i.e. from 400 nm to 600 nm.

In some embodiments, the carbon-containing precursor is present in gaseous form at room temperature.

In some embodiments, the metallic component which is to be formed and is to be treated or coated serves as counterelectrode of a plasma generation module.

As another example, some embodiments include a process for coating surfaces of metallic components, wherein at least one surface of a metallic component is coated with an organic protective layer by means of an atmospheric pressure plasma generation module.

In some embodiments, the organic protective layer is removed again in its entirety or partly by means of the atmospheric pressure plasma generation module in a later process step.

In some embodiments, a precursor which is carbon-containing is introduced into the plasma generation module.

In some embodiments, a carbon-containing precursor which is present in gaseous form at room temperature is used for generating the plasma.

In some embodiments, an organic, i.e. carbon-containing, precursor or a metal-organic, i.e. carbon- and metal-containing, precursor is used for plasma formation.

In some embodiments, a precursor selected from the group consisting of organosilicon compounds is used as metal-organic precursor.

In some embodiments, acetylene is used as carbon-containing compound as precursor.

In some embodiments, a process gas is used for removing the organic protective layer.

In some embodiments, there is an apparatus for carrying out the process as recited above.

### DETAILED DESCRIPTION

In some embodiments, the teachings of the present disclosure provide a metallic component having an organic protective layer which has been applied to at least part of the surface in order to reduce friction and is obtainable and removable again by treatment with a carbon-containing precursor by means of an atmospheric pressure plasma. In some embodiments, the teachings provide a process for plasma coating metallic components, wherein a carbon-containing compound, in particular an unsaturated carbon-containing compound, is deposited in the form of a coating on the surface or parts of the surface by means of an atmospheric pressure plasma process.

As a result of the plasma polymerization as disclosed here under atmospheric conditions, i.e. without an additional outlay in terms of apparatus and time, simply by use of a plasma generation module on the surfaces to be coated, the surfaces concerned are provided locally by means of plasma with a thin, organic protective layer before the process step associated with the frictional movement, with inexpensive organic precursors, preferably acetylene, being used. The layer which has been applied in this way then serves, in a manner analogous to a conventionally employed lubricant, as protective layer to avoid direct frictional contact between the friction partners. This gives improved sliding properties during joining and/or detachment, and the protective layer can be removed again by the same plasma treatment without precursor after the process step, depending on requirements.

It has surprisingly been found that the treatment with an atmospheric pressure plasma generation module and a carbon-containing, e.g., unsaturated, organic or metal-organic compound as precursor produces layers deposited under the atmospheric pressure plasma which have a polymer-like character, good sliding properties and/or low coefficients of sliding friction. In some embodiments, the layer and/or the protective action can be applied in a particularly simple way in a tailored manner, i.e. locally on the component in a defined thickness with sufficiently good adhesion and sliding effect.

In some embodiments, the places on the surface which are difficult to access can be coated by the use of atmospheric pressure plasma generation modules which are suitable for this purpose. The plasma generation module can be used in a simple manner like a compressed air gun. Compared to the oil-based lubricant layers, the organic protective layers proposed here are less sensitive, more heat-resistant, have constant sliding properties at various temperatures and are easily removable again.

In some embodiments, a uniform coating on all surfaces which are relevant in respect of frictional damage can be produced using a plasma generation module, in particular one which operates under atmospheric pressure, i.e. does not necessarily require a closed pressure chamber for plasma generation. For the present purposes, a plasma generation module is a one-piece or multipart module by means of which a plasma can be generated. This can be, for example, a plasma nozzle, an electrode configuration having at least one or more electrodes and/or another plasma source.

The plasma generation module may be equipped for producing a spatially limited plasma. Compared to a plasma which extends essentially over the entire interior surface of a plasma pressure chamber, the region to be coated is adjustable, with a plasma nozzle being able to be handled like a compressed air gun. In addition, the activation of the precursor during coating can be carried out directly in the region of the surface to be coated. For this purpose, the plasma generation module comprises, for example, a plasma nozzle by means of which an atmospheric plasma beam can be produced. In a corresponding embodiment of the plasma generation module, the plasma nozzle may be equipped for producing an atmospheric plasma beam.

In some embodiments, the plasma nozzle comprises a precursor feed conduit through which a prescribed precursor can be applied as plasma with or without process gas and/or ambient air to the surface of a tool and/or a metallic component or parts thereof. In treatment by means of atmospheric pressure plasma, the metallic component is provided locally with a thin, organic protective layer in the nanometer range, i.e. basically having a layer thickness of less than 1 μm, by plasma polymerization under atmospheric conditions, i.e. without an additional outlay in terms of apparatus and/or time, using inexpensive organic precursors, in particular unsaturated carbon compounds, i.e. compounds having carbon-carbon multiple bonds, which are gaseous at room temperature, as coating material.

In some embodiments, a polymeric organic protective layer is applied by means of atmospheric pressure plasma in comparison to a conventionally applied oil-based protective layer may improve the layer thickness but also the nature of the layer. Thus, the organic protective layer which had been applied by means of plasma has a robust nature because despite the small layer thickness it displays an at least equivalent effectiveness against the above-described furrow and/or scratch formation in tests.

This is, in particular, also a consequence of the atmospheric pressure plasma application because this makes structure-retaining plasma coating possible. By this it is meant that, for example, a layer applied by low pressure plasma using the same precursors does not display structure-retaining layer formation because the precursor molecules are decomposed and/or even ionized to a greater extent by an applied low-pressure plasma.

In the case of the atmospheric pressure plasma, “structure-retaining coating” means, for example, that the use of a precursor having a carbon:silicon ratio of, for example, 6:2 by atmospheric pressure plasma coating forms a layer which still has a ratio of carbon to silicon of 2:1 on the metallic component. Here, a dense layer having few pores, few cracks and a good degree of crosslinking or layer cohesion can be formed.

In some embodiments, when the surface of the metallic component has, for example, a thermal conductivity in the range from 10 to 150 W/mK, removal of heat from the molecules or molecule fragments deposited from the atmospheric pressure plasma takes place and this assists the formation of a stable protective layer having good layer cohesion. In some embodiments, the organic protective layer present on the surface as a result of the atmospheric pressure plasma is removed again after the process step involving friction.

An organic or metal-organic protective layer produced by means of atmospheric pressure plasma is present in, for example, a layer thickness of less than 500 nm and displays discoloration which is influenced by interference effects of the layer. At layer thicknesses in the region of 80 nm or below, in particular from 50 to 70 nm, the color can also be influenced in a pronounced manner by absorption characteristics of the layer. For example, an organic protective layer on a stainless steel surface which has been produced using acetylene as precursor and under atmospheric pressure plasma has an absorption in the range from 400 nm to 600 nm wavelength, i.e. in the visible region, and a yellow-brownish coloration.

In some embodiments, the plasma generation module can be in mobile form and be able to be used independently of other machines. The atmospheric plasma beam may be generated by means of an electric discharge in a working gas, in particular in the plasma nozzle. The atmospheric plasma beam may be generated by an arc discharge produced using a high-frequency effective voltage, depending on the way it is looked at also an arc-like discharge, in a working gas. Typically, a high-frequency high voltage is a voltage of from 1 to 100 kV, in particular from 1 to 50 kV, from 1 to 50 kV, at a frequency of from 1 to 150 kHz, from 10 to 80 kHz, from 10 to 65 kHz, or even from 10 to 50 kHz. On the other hand, the plasma can also be operated with discharges having a lower voltage, for example in the region of an effective power of less than 500 W, in particular in the region of 300 W, for example in the range from 200 to 300 W. In this case, an effective voltage of, for example, about 1 kV and an effective current of 0.3 A are present.

This generates a plasma beam which firstly has a high reactivity and secondly has a comparatively low temperature. Effective treatment of the surfaces or effective activation of the precursor and thus effective and uniform coating or cleaning can be achieved by means of the high reactivity. Secondly, damage to the surface can be avoided as a result of the low temperature of the plasma beam.

In the surface treatment, in particular in surface coating, the metallic component can itself function as counterelectrode of the plasma generation module. For this purpose, the component can, in particular, be maintained at a fixed potential, for example grounded. Such a counterelectrode can, for example, be moved together with the plasma generation module for surface treatment or surface coating. The counterelectrode can, in particular, also be configured as part of the plasma generation module.

In some embodiments, a high-frequency voltage is applied between an electrode of the plasma generation module and a counterelectrode in such a way that a direct discharge occurs between the electrode and the counterelectrode. For the purposes of the present invention, a direct discharge is, in contrast to a dielectric barrier discharge, a discharge in the case of which the electrode and the counterelectrode are not electrically insulated from one another so that direct discharges between the electrode and the counterelectrode are possible. The discharges between the electrode and the counterelectrode can be, in particular, electric arc-like high-frequency discharges in the case of which individual discharge filaments go over from the electrode to the counterelectrode or vice versa.

In some embodiments, the process for plasma coating a metallic component includes a process gas stream flowing into the region of the direct discharges between the electrode and the counterelectrode. In some embodiments, the plasma generation module comprises an electrode and a process gas feed conduit, with the electrode being equipped for being supplied with a high-frequency high voltage from a voltage source and the process gas feed conduit being configured for introducing a process gas stream, for example a process gas stream which also moves laterally, into the region of the electrode. A moving process gas stream means that the process gas stream has a velocity component in the longitudinal direction or in the direction of movement of the plasma generation module and additionally a velocity component perpendicular thereto, so that the process gas stream also, for example, rotates and in some cases forms a type of vortex. It has been found that the high-frequency discharges are influenced by such a rotating process gas stream so that stable and uniform operation is possible. In particular, a more uniform distribution of the plasma or of the precursor on the surface region to be treated or to be coated can be achieved in this way.

To generate a rotating process gas stream, the process gas feed conduit can, for example, have a ring of holes which are set obliquely in the circumferential direction, by means of which an inflowing process gas stream is converted into a rotating process gas stream.

In some embodiments, an apparatus for carrying out the process includes the feed conduit for the precursor arranged so as to be movable, in particular also a feed conduit for a carrier gas. This makes continuous and uniform or meterable introduction of the precursor gas possible, so that uniform coating of the desired surfaces can be achieved. The precursor can also be introduced in gaseous or liquid form through a precursor feed conduit connected to the plasma generation module. In some embodiments, the precursor can be conveyed by means of such a precursor feed conduit, in particular a precursor lance, right into the region of the plasma. Furthermore, such a precursor feed conduit allows the precursor to be fed at a defined place into the plasma and, for example, spatial separation of the centre of the discharges and the activation zone for the precursor thus to be achieved.

In some embodiments, the apparatus has a precursor feed conduit which is configured for conveying a precursor into the region of a plasma generated by means of the plasma generation module. The apparatus can, for example, have a precursor feed conduit which is configured for conveying a precursor by means of a carrier gas onto the surface of the metallic component.

In some embodiments, the metallic component is provided with a friction-reducing coating, in particular an organic protective layer in the nanometer range, i.e. having a layer thickness of less than 1000 nm or less than 1 μm, by means of the treatment with plasma, in particular atmospheric pressure plasma. The coating may have a thickness in the range from 5 nm to 1000 nm, for example from 50 nm to 500 nm, in particular from 100 nm to 400 nm, or even from 200 nm to 300 nm.

In some embodiments, the plasma generation module is, after conclusion of the friction-reducing process step, used for removing the organic protective layer on the surface of the metallic component and/or on parts thereof.

The plasma generated by means of the nozzle may be a plasma discharge obtained by means of a corona discharge, by means of a dielectric barrier discharge or by means of an electric arc-like discharge.

For the present purposes, a precursor is a substance which is suitable for forming a coating on the surface of a metallic component. For example, the precursor can be a chemical compound which gives the desired coating material by polymerization or by means of another chemical reaction. The precursor can, for example, be fragmented and/or partially ionized by interaction with the plasma, so that its reactivity is increased. Furthermore, the plasma can also provide necessary activation energy required for a chemical reaction of the precursor, in particular for a polymerization. For example, a precursor can be an organic compound, in particular a hydrocarbon-containing compound, or a metal-organic compound. For example, a precursor can be simply petroleum spirit and/or diesel oil. In particular, it is possible to use aliphatic and/or cyclic hydrocarbons as precursors. The precursor can, for example, be present in liquid or gaseous form and be used with or without process gas.

As precursors for the organic protective coating provided by way of example here on at least part of a surface of a metallic component, metal-organic compounds, in particular organosilicon compounds such as alkyl-functional silanes, e.g. HMDSO:hexamethyldisiloxane, TEOS, VTMS: vinyltrimethylsilane, OMCTS:octamethyltetracyclosiloxane; also hydrocarbons, in particular hydrocarbons having at least one carbon-carbon multiple bond; short-chain hydrocarbons such as methane; unsaturated hydrocarbons such as acetylene, ethene; short-chain hydrocarbons which are present in gaseous form at room temperature and also any cycloaromatics, cycloaliphatics, halogen- or pseudohalogen-substituted and/or cyclic hydrocarbons, for example fluorine-containing hydrocarbons such as octafluorocyclobutane, octafluorocyclopentane and any mixtures thereof, for example, are provided.

In some embodiments, the metallic component is freed of the friction-reducing protective coating in the nanometer range by treatment with atmospheric pressure plasma without precursor. Here, for example, the nozzle of the plasma generation module is operated using air, oxygen, hydrogen, argon and/or CF₄/C₂F₆ or any mixtures thereof as process gas and/or at a moderate to high power. However, a precursor is not necessary in this cleaning phase as long as the operation is carried out in air. The highly reactive plasma leads, under atmospheric conditions, to oxidation of the organic protective layer and removes the latter. Further wet cleaning of the surface is no longer necessary.

Although the organic protective layer on the finished product is generally no longer visible to the human eye, the material applied by means of the atmospheric plasma is still detectable with a high probability. It is possible to check by means of, in particular, IR-ATR-spectroscopic methods, EDX/WDX methods or microscopic examination whether an organic protective layer according to the present invention has been present. The reason is that complete cleaning by means of atmospheric pressure plasma would be achievable technically without problems, but would require disproportionately long treatment times since the material is more difficult to remove on microcavities on the metal surface.

Example for the production of the organic protective layer by means of atmospheric pressure plasma and a hydrocarbon-containing compound, in particular an acetylene-containing compound, as precursor:

In some embodiments, process parameters for producing the organic protective layer by means of atmospheric pressure plasma may include:
atmospheric plasma, afterglow by means of convergent free-jet nozzle, tungsten-copper, d about 4 mm
ionizing gas nitrogen (1500 1/h)
pulsed AC arc discharge with
   plasma voltage: 280 V
   plasma frequency: 21 kHz
   plasma cycle time: 10%
   precursor: acetylene, about 40 1/h
   one-point feed into free-jet nozzle
target corridor: plasma with effective power of about 300 W, effective voltage about 1 kV, effective current 0.3 A, two pulses per period, at peak 3.8 kV, pulse duration=1.4 μs deviation tolerance +/−25%.

Some embodiments include a metallic component having a friction-reducing surface coating, in particular also having a protective coating against mechanical damage, and also a process for carrying out surface coating. To reduce the damage occurring as a result of friction losses and friction damage during a treatment process and energy losses, it is proposed that a plasma generation module by means of which selected surfaces of the metallic component can be coated with an organic protective coating in the nanometer range be provided.

What is claimed is:

1. A metallic component having comprising:
a base metal form with at least one surface;
an organic protective layer applied to at least part of the at least one surface to reduce friction; and
wherein the organic protective layer is applied by treatment with a carbon-containing precursor by means of an atmospheric pressure plasma.

2. The component as claimed in claim 1, wherein the coated surface has a thermal conductivity in the range from 10 to 150 W/mK.

3. The component as claimed in claim 1, wherein the carbon-containing precursor comprises an unsaturated compound having at least one carbon-carbon multiple bond.

4. The component as claimed in claim 1, wherein the organic protective layer has a thickness of less than 1 μm.

5. The component as claimed in claim 1, wherein the organic protective layer has a thickness of less than 500 nm.

6. The component as claimed in claim 1, wherein the organic protective layer has an absorption in the wavelength range of visible light.

7. The component as claimed in claim 1, wherein the carbon-containing precursor is present in gaseous form at room temperature.

8. The component as claimed in claim 1, wherein the base metal form serves as a counterelectrode for a plasma generation module.

9. A process for coating surfaces of metallic components, the process comprising:
coating at least one surface of a base metal body with an organic protective layer with an atmospheric pressure plasma generation module.

10. The process as claimed in claim 9, further comprising at least partially removing the organic protective layer with the atmospheric pressure plasma generation module.

11. The process as claimed in claim 9, further comprising delivering a carbon-containing precursor into the plasma generation module.

12. The process as claimed in claim 9, further comprising using a carbon-containing precursor in gaseous form at room temperature for generating the plasma.

13. The process as claimed in claim 9, further comprising using an organic precursor for plasma formation.

14. The process as claimed in claim 9, further comprising using an organosilicon as a precursor for plasma formation.

15. The process as claimed in claim 9, further comprising using acetylene as a precursor for plasma formation.

16. The process as claimed in claim 9, further comprising using a process gas for removing the organic protective layer.

17. (canceled)
